(19) United States
(12) Patent Application Publication
(10) Pub. No.: US 2026/0220798 A1
(43) Pub. Date: Jul. 30, 2026

(54) POINT MAP REGISTRATION USING SEMANTIC INFORMATION

(71) Applicant: QUALCOMM Incorporated, San Diego, CA (US)

(72) Inventors: Xinyu LIN, Chengdu (CN); Ling CHEN, Chengdu (CN); Yufeng HE, Chengdu (CN); Xuemei ZHENG, Chengdu (CN)

(21) Appl. No.: 19/151,961

(22) PCT Filed: Mar. 24, 2023
(86) PCT No.: PCT/CN2023/083748

§ 371 Date: Jul. 29, 2025

(51) Int. Cl. G06T 7/33; G06T 7/246; G06T 7/73

(52) U.S. Cl. CPC G06T 7/337; G06T 7/248; G06T 7/74; G06T 2207/30252

(57) ABSTRACT

Systems and techniques are provided for performing point map registration. For example, a process can include obtaining an image comprising a plurality of 3D points representing a scene and determining, based on the image, a first point map representing the scene. The process includes determining a first plurality of point groupings based on proximity of pairs of points of the first plurality of 3D points. The process includes obtaining a second point map comprising a second plurality of point groupings representing the scene. The process includes determining a correspondence between individual point groupings of the first plurality of point groupings and individual point groupings of the second plurality of point groupings. The process includes determining, based on the correspondence between individual point groupings of the first plurality and individual point groupings of the second plurality, an alignment transformation for aligning the first and the second plurality of 3D points.

### FIELD OF THE DISCLOSURE

Aspects of the disclosure relate generally to object detection and tracking. In some implementations, systems and techniques are described for performing reference map registration using semantic information.

### BACKGROUND OF THE DISCLOSURE

Object detection and tracking can be used to identify an object (e.g., from a digital image or a video frame of a video clip) and track the object over time. Object detection and tracking can be used in different fields, including transportation, video analytics, security systems, robotics, aviation, among many others. In some fields, a tracking object can determine positions of other objects (e.g., target objects) in an environment so that the tracking object can accurately navigate through the environment. In order to make accurate motion and trajectory planning decisions, the tracking object may also have the ability to estimate various target object characteristics, such as pose (e.g., including position and orientation) and size.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems and techniques for performing point map registration using semantic information. According to at least one example, a method is provided for performing point map registration (use preamble). The method includes: obtaining an image comprising a scene; determining, based on the image, a first point map representing the scene, wherein the first point map comprises a first plurality of three-dimensional (3D) points representing the scene; determining a first plurality of point groupings, wherein each point grouping of the first plurality of point groupings is determined based on proximity of pairs of points of the first plurality of 3D points, wherein each point grouping includes two or more 3D points from the first plurality of 3D points; obtaining a second point map representing the scene, wherein the second point map comprises a second plurality of 3D points representing the scene; obtaining a second plurality of point groupings, wherein each point grouping of the second plurality of point groupings includes a plurality of 3D points from the second plurality of 3D points; determining a correspondence between individual point groupings of the first plurality of point groupings and individual point groupings of the second plurality of point groupings; and determining, based on the correspondence between individual point groupings of the first plurality of point groupings and individual point groupings of the second plurality of point groupings, an alignment transformation for aligning the first plurality of 3D points and the second plurality of 3D points.

In another example, an apparatus for performing point map registration is provided that includes at least one memory and at least one processor coupled to the at least one memory. The at least one processor is configured to: obtain an image comprising a scene; determining, based on the image, a first point map representing the scene, wherein the first point map comprises a first plurality of 3D points representing the scene; determine a first plurality of point groupings, wherein each point grouping of the first plurality of point groupings is determined based on proximity of pairs of points of the first plurality of 3D points, wherein each point grouping includes two or more 3D points from the first plurality of 3D points; obtain a second point map representing the scene, wherein the second point map comprises a second plurality of 3D points representing the scene; obtain a second plurality of point groupings, wherein each point grouping of the second plurality of point groupings includes a plurality of 3D points from the second plurality of 3D points; determine a correspondence between individual point groupings of the first plurality of point groupings and individual point groupings of the second plurality of point groupings; and determining, based on the correspondence between individual point groupings of the first plurality of point groupings and individual point groupings of the second plurality of point groupings, an alignment transformation for aligning the first plurality of 3D points and the second plurality of 3D points.

In another example, a non-transitory computer-readable medium is provided that has stored thereon instructions that, when executed by one or more processors, cause the one or more processors to: obtain an image comprising a scene; determining, based on the image, a first point map representing the scene, wherein the first point map comprises a first plurality of 3D points representing the scene; determine a first plurality of point groupings, wherein each point grouping of the first plurality of point groupings is determined based on proximity of pairs of points of the first plurality of 3D points, wherein each point grouping includes two or more 3D points from the first plurality of 3D points; obtain a second point map representing the scene, wherein the second point map comprises a second plurality of 3D points representing the scene; obtain a second plurality of point groupings, wherein each point grouping of the second plurality of point groupings includes a plurality of 3D points from the second plurality of 3D points; determine a correspondence between individual point groupings of the first plurality of point groupings and individual point groupings of the second plurality of point groupings; and determining, based on the correspondence between individual point groupings of the first plurality of point groupings and individual point groupings of the second plurality of point groupings, an alignment transformation for aligning the first plurality of 3D points and the second plurality of 3D points.

In another example, an apparatus for performing point map registration is provided. The apparatus includes: means for obtaining an image comprising a scene; determining, based on the image, a first point map representing the scene, wherein the first point map comprises a first plurality of 3D points representing the scene; means for determining a first plurality of point groupings, wherein each point grouping of the first plurality of point groupings is determined based on proximity of pairs of points of the first plurality of 3D points, wherein each point grouping includes two or more 3D points from the first plurality of 3D points; means for obtaining a second point map representing the scene, wherein the second point map comprises a second plurality of 3D points representing the scene; means for obtaining a second plurality of point groupings, wherein each point grouping of the second plurality of point groupings includes a plurality of 3D points from the second plurality of 3D points; means for determining a correspondence between individual point groupings of the first plurality of point groupings and individual point groupings of the second plurality of point groupings; and determining, based on the correspondence between individual point groupings of the first plurality of point groupings and individual point groupings of the second plurality of point groupings, an alignment transformation for aligning the first plurality of 3D points and the second plurality of 3D points.

In some aspects, one or more of the apparatuses described herein is, is part of, or includes a vehicle or a computing device or system of a vehicle, a mobile device (e.g., a mobile telephone or so-called “smart phone” or other mobile device), a wearable device, an extended reality device (e.g., a virtual reality (VR) device, an augmented reality (AR) device, or a mixed reality (MR) device), a personal computer, a laptop computer, a server computer, or other device. In some aspects, an apparatus includes a camera or multiple cameras for capturing one or more images. In some aspects, the apparatus includes a display for displaying one or more images, notifications, and/or other displayable data. In some aspects, the apparatus can include one or more sensors. In some cases, the one or more sensors can be used for determining a location and/or pose of the apparatus, a state of the apparatuses, and/or for other purposes.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 is an image illustrating multiple vehicles driving on a road, in accordance with some examples;

FIG. 2A is a diagram illustrating an example point map of a road, in accordance with some examples;

FIG. 2B and FIG. 2C are diagrams illustrating an example point map registration, in accordance with some examples;

FIG. 3 is a block diagram illustrating an example of a point map registration system, in accordance with some examples;

FIG. 4A and FIG. 4B are diagrams illustrating example point maps, in accordance with some examples;

FIG. 5A, FIG. 5B. and FIG. 5C are diagrams illustrating an example dynamic time warping calculation, in accordance with some examples;

FIG. 6 is a diagram illustrating correspondence between point groupings and individual points of two point maps, in accordance with some examples;

FIG. 7 is a diagram illustrating an example registration between point maps, in accordance with some examples;

FIG. 8 is a flowchart illustrating an example of a process for performing object detection and tracking using the techniques described herein, in accordance with some examples;

FIG. 9 is a block diagram illustrating an example of a deep neural network, in accordance with some examples;

FIG. 10 is a diagram illustrating an example of the Cifar-10 neural network, in accordance with some examples;

FIG. 11A through FIG. 11C are diagrams illustrating an example of a single-shot object detector, in accordance with some examples;

FIG. 12A through FIG. 12C are diagrams illustrating an example of a You Only Look Once (YOLO) detector, in accordance with some examples; and

FIG. 13 is a block diagram of an exemplary computing device that may be used to implement some aspects of the technology described herein, in accordance with some examples.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein can be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes can be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Object detection can be used to detect or identify an object in an image or frame. Object tracking can be performed to track the detected object over time. For example, an image of an object can be obtained, and object detection can be performed on the image to detect one or more objects in the image. In some cases, a three-dimensional (3D) point map can include a 3D representation of the object in the image.

Object detection and tracking can be used in driving systems, video analytics, security systems, robotics systems, aviation systems, extended reality (XR) systems (e.g., augmented reality (AR) systems, virtual reality (VR) systems, mixed reality (MR) systems, etc.), among other systems. In such systems, an object (referred to as a tracking object) tracking other objects (referred to as target objects) in an environment can determine positions and/or sizes of the other objects. Determining the positions and/or sizes of target objects in the environment allows the tracking object to accurately navigate the environment by making intelligent motion planning and/or trajectory planning decisions.

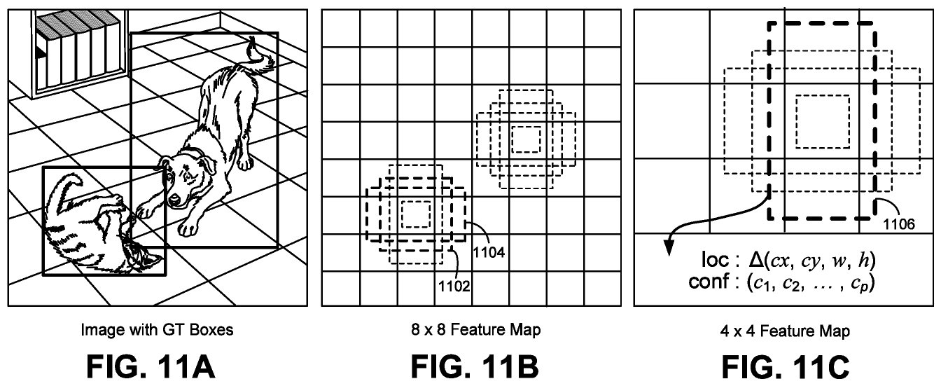

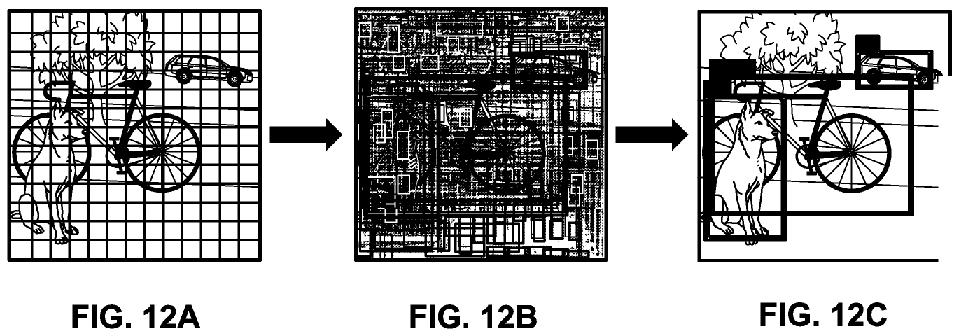

In some cases, machine-learning models (e.g., deep neural networks) can be used for performing object detection and localization in some cases. Machine-learning based object detection can be computationally intensive, can be difficult to implement in contexts where detection speed is a high-priority, among other difficulties. For example, machine-learning based object detection can be computationally intensive as they are typically run on the entire image and (either implicitly or explicitly) at various scales to capture target objects (e.g., target vehicles) at different distances from a tracking object (e.g., a tracking or ego vehicle). Examples of the numerous scales that may be considered by a neural-network based object detector are shown in and described below with respect to FIG. 11A through FIG. 11C and FIG. 12A through FIG. 12C.

In some cases, an object detection and tracking system can track (e.g., using an object tracker) the location of a tracking object (e.g., a tracking vehicle) relative to a reference map. Object tracking can be performed across multiple successive images (or frames), for example, that are received by the tracking object, e.g., captured by an image-capture device, such as a camera, Light Detection and Ranging (LiDAR) sensor, and/or a radar sensor of the tracking object). Object tracking can also be performed using data (e.g., images or frames) from multiple different sensors. For example, object tracking can be performed by a tracking system that analyzes data from both a LiDAR sensor and an image-capture device. In some cases, two-dimensional (2D) representations of objects captured by sensors such as the image-capture device, LiDAR, and/or radar can be converted to a 3D representation of the environment surrounding the tracking object. In some cases, the 3D representation of the environment can be a point map. However, existing systems do not take into account semantic information of an environment.

Systems, apparatuses, processes (methods), and computer-readable media (collectively referred to as “systems and techniques”) are described herein for performing road registration using semantic information. For example, the systems and techniques provide solutions to improve registration between reference point maps (e.g., from an accurate road map) and point maps (also referred to herein as point clouds) generated based on captured images (e.g., by a tracking and detection system). As used herein, the term registration refers to a process of determining a spatial transformation (e.g., rotation and/or translation) that aligns two (or more in some cases) point maps. The systems and techniques described herein can be applied to any scenario, such as scenarios where fast and/or accurate detections are necessary, where compute resources are limited, among others.

In some aspects, a detection and tracking system of a tracking object (e.g., a tracking vehicle) can receive or obtain images containing a target object (e.g., a road). Some detection and tracking systems may also generate 3D models of the environment surrounding the tracking object, including a 3D point map of a road (or other surface) In some cases, features of the road such as lane markings (e.g., lane lines) can be represented as individual points in the 3D point map of the environment surrounding the tracking object. A point map registration system can perform a registration between point maps generated based on images captured by the object tracking and detection system a reference point map representation. In some cases, accurate registration can provide a better understanding of the position of the tracking object relative to the road (e.g., lane position). In some implementations, the systems and techniques described herein can be used for accurate real-time vehicle position tracking.

In some cases, semantic information can be used to improve registration between point maps. For example, in the case wheels of a vehicle driving on a road (or on another surface), a registration system can leverage semantic information about the road to improve registration. For example, points in the point maps corresponding to road markings (e.g., lane lines) can be grouped together in groups corresponding to individual line segments. For example, points in a point map can be grouped together as lines based on distances between adjacent points. In some cases, correspondence between the line segments can include generating a registration between a sensed point map generated based on captured images of a road and a reference point map of the road.

Examples are described herein using vehicles as illustrative examples of tracking objects and roads as illustrative examples of target objects. However, one of ordinary skill will appreciate the systems and related techniques described herein can be included in and performed by any other system or device for detecting and/or tracking any type of objects in one or more images. Examples of other systems that can perform or that can include components for performing the techniques described herein include robotics systems, extended reality (XR) systems (e.g., augmented reality (AR) systems, virtual reality (VR) systems, mixed reality (MR) systems, etc.), video analytics, security systems, aviation systems, among others systems. Examples of other types of objects that can be detected include people or pedestrians, infrastructure (e.g., roads, signs, etc.), among others. In one illustrative example, a tracking vehicle can perform one or more of the techniques described herein to detect a pedestrian or infrastructure object (e.g., a road sign) in one or more images.

The systems and techniques described herein provide advantages over existing object detection and tracking systems. For example, the systems and techniques can be used to update a point map (e.g., for a sensed road network) such that the point map has an accurate registration with a reference point map and accordingly provides a more precise reference for object localization (e.g., real-time object localization, such as real-time vehicle localization).

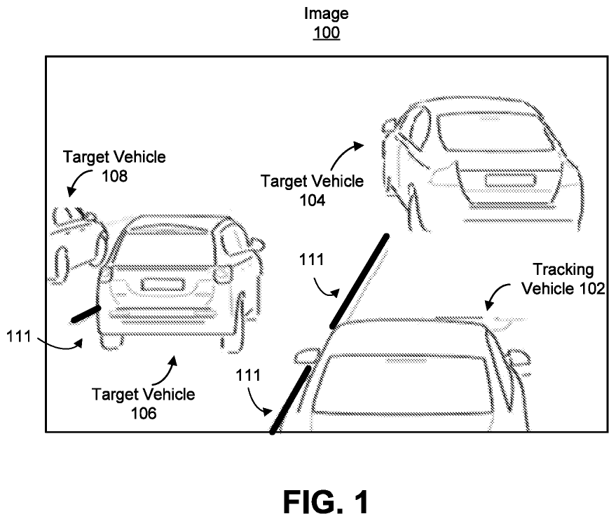

Various aspects of the application will be described with respect to the figures. FIG. 1 is an image 100 illustrating an environment including numerous vehicles driving on a road. The vehicles include a tracking vehicle 102 (as an example of a tracking object), a target vehicle 104, a target vehicle 106, and a target vehicle 108 (e.g., as examples of tracking object). The tracking vehicle 102 can track the target vehicles 104, 106, and 108 and/or lane lines 111 in order to navigate the environment. For example, the tracking vehicle 102 can determine the position of the tracking vehicle 102 to determine when to slow down, speed up, change lanes, and/or perform some other function. While the vehicle 102 is referred to as a tracking vehicle 102 and the vehicles 104, 106, and 108 are referred to as target vehicles with respect to FIG. 1, the vehicles 104, 106, and 108 can also be referred to as tracking vehicles if and when they are tracking other vehicles, in which case the other vehicles become target vehicles.

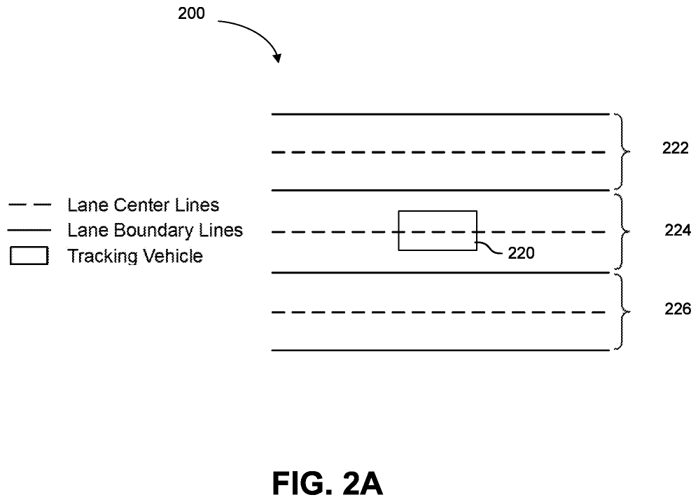

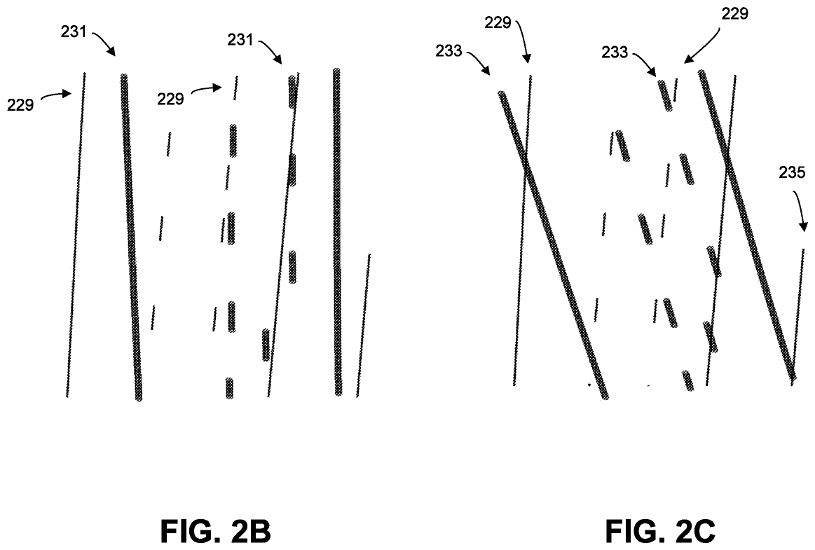

FIG. 2A is a diagram illustrating an example of information that can be included in a point map 200 and/or generated using points in the point map 200. The example in FIG. 2A shows three lanes of a highway from a top perspective view (or “birds eye view”), including a left lane 222, a middle lane 224, and a right lane 226. Each lane is shown with a center line and two boundary lines, with the middle lane 224 sharing a boundary line with the left lane 222 and the right lane 226. A vehicle 220 is shown in the middle lane 224. One or more cameras on the vehicle can capture images of the environment surrounding the vehicle, as described herein. In some examples, the point map 200 can include points (or waypoints) representing the lines of the lanes. For example, each line can be defined by a number of points. In some cases, the road represented by the point map 200 can be represented as a plane in a three-dimensional representation of the tracking vehicle 220 and its surroundings.

In some aspects, the point map 200 can include a plurality of map points corresponding to one or more reference locations in a 3D space. In one example using autonomous vehicles as an illustrative example of objects, the points of the point map 200 define stationary physical reference locations related to roadways, such as road lanes and/or other data. For example, the point map 200 can represent lanes on the road as a connected set of points. Line segments are defined between two map points, where multiple line segments define the different lines of the lanes (e.g., boundary lines and center lines of a lane). The line segments can make up a piece-wise linear curve defined using the map points. For example, the connected set of points (or segments) can represent the center lines and the boundary lines of a lane on a road, which allow an autonomous vehicle to determine where it is located on the road and where target objects are located on the road. In some cases, the point map 200 can represent the road (or localized regions of the road) as a plane in 3D space (e.g., a road plane or ground plane).

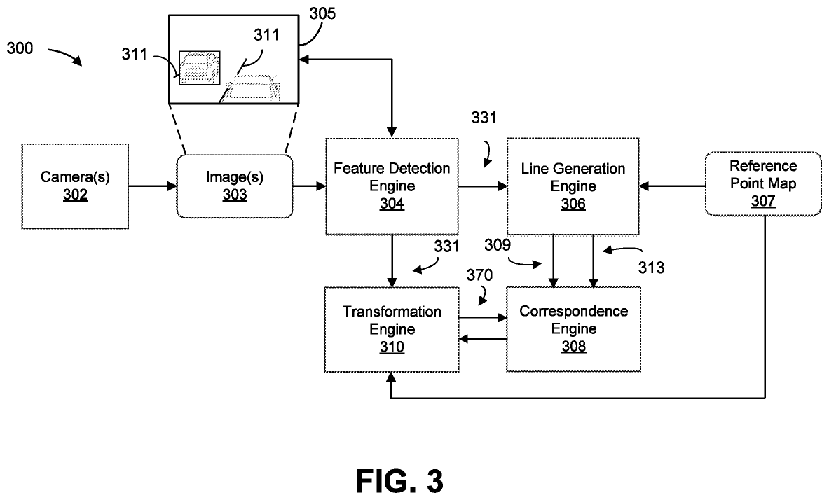

In some cases, reference locations in an environment can be included in a reference point map (e.g., reference point map 307 of FIG. 3). In some cases, the reference point map (e.g., reference point map 307 of FIG. 3) can be referred to as a high-definition (HD) map. In some cases, different reference points maps can be maintained for different areas of the world (e.g., a reference point map for New York City, a reference point map for San Francisco, a reference point map for New Orleans, and so on). In some examples, the different reference point maps can be included in separate data files (e.g., Geo-JavaScript Object Notation (GeoJSON) files, ShapeFiles, comma-separated values (CSV) files, and/or other files).

In some implementations, a point map registration can be used to determine a correspondence between the point map 200 and the reference point map. In one illustrative example, point map registration can determine a correspondence between the point map 200 and a portion of a reference point map corresponding to a same location (e.g., a particular position on a highway). In one illustrative example, an iterative closest point (ICP) algorithm can be used to perform the registration. The ICP algorithm can include a data association step, and a transformation step. In one illustrative example, a data association can be determined based on a closest point between each point of the point map 200 and the reference point map (e.g., reference point map 307 of FIG. 3). In some cases, an initial alignment between the point map 200 and the reference point map can be approximated based on one or more assumptions (e.g., an orientation relative to a reference direction). In some cases, the transformation step can be performed by determining a center of mass of each point map and performing a transformation to align the center of mass of the point map 200 and the center of mass of the reference point map. In each iteration of the ICP algorithm, a new data association can be performed on the transformed point map from the previous iteration. In some cases, after the new data association is determined, a new transformation can be determined to align the point maps based on the new data association. In some cases, the ICP algorithm can be repeated until a maximum number of iterations is reached or until the data alignment and transformation approach convergence.

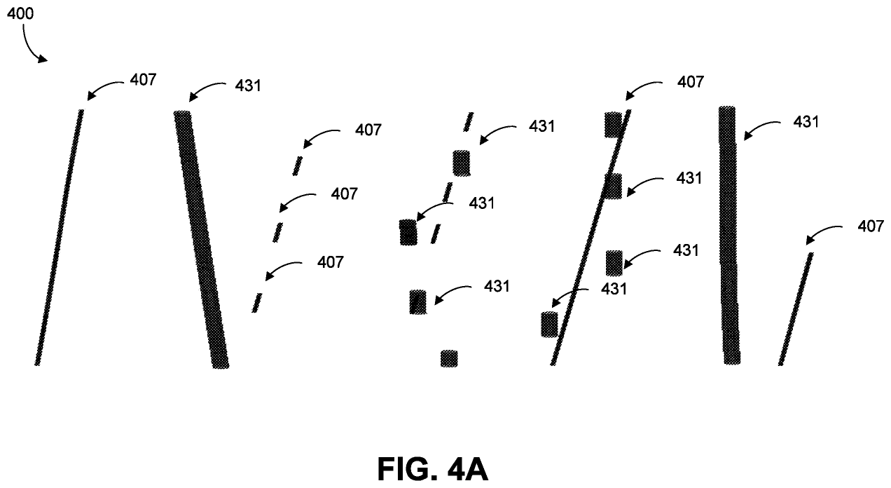

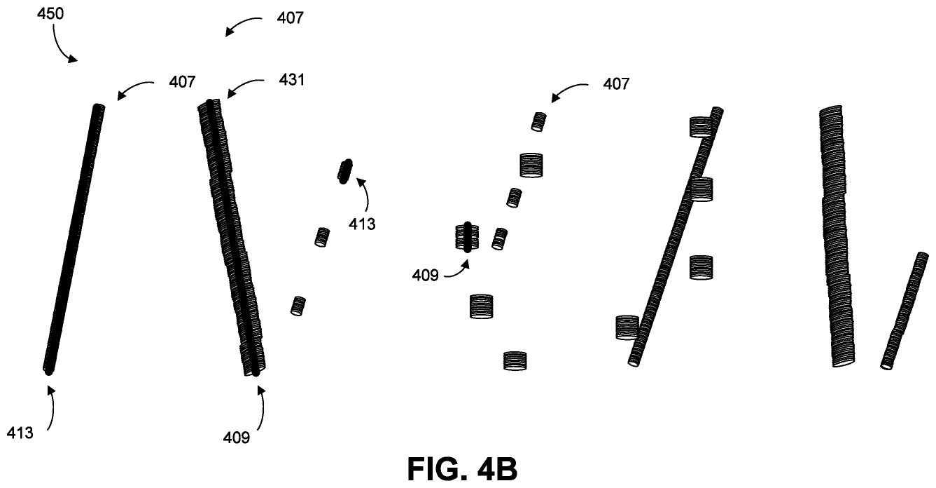

FIG. 2B and FIG. 2C illustrate an example point map registration utilizing an ICP algorithm for determining correspondence between point map points. In FIG. 2B, the thin lines can correspond to points in a reference point map 229. As illustrated, the thick lines correspond to points in a point map 231 captured by a tracking object (e.g., tracking vehicle 102 of FIG. 1). In the illustration of FIG. 2B, the solid lines of the point maps 229, 231 are comprised of individual points in close proximity to one another (see, e.g., FIG. 4B). In the example of FIG. 2B, the relative positioning of the point maps 229, 231 can correspond to an initial estimate for the correspondence between the point maps. FIG. 2C illustrates an example of a transformed point map 233 generated by applying a transformation (e.g., a transformation matrix) determined by a point-to-point correspondence determined by an ICP algorithm applied to the point map 231. In the illustrated example of FIG. 2C, the point map 233 is shown with a greater misalignment relative to the reference point map 229 than the initial estimate shown in point map 231. In some cases, the added misalignment can result from mismatched points 235 that are present in one point map while being absent from the other point map. In the example of FIG. 2B and FIG. 2C, the registration technique applies minimal semantic information about the data in each point map 229, 231. In some cases, semantic information (e.g., groupings of points in the point maps 229, 231 correspond to line segments) can be leveraged to improve the registration.

FIG. 3 is a block diagram illustrating an example of a point map registration system 300 for performing a registration between a point map generated from captured images and a reference point map. The point map registration system 300 can be included in a tracking object that tracks one or more target objects. In some cases, the point map registration system 300 can be included in, and/or be in communication with an object detection and tracking system. As noted above, a tracking object refers to an object that tracks one or more other objects, which are referred to as target objects. In one illustrative example, the point map registration system 300 can include, can be included in, and/or can be in communication with an autonomous driving system included in an autonomous vehicle (as an example of a tracking object). In another illustrative example, the point map registration system 300 can include, can be included in, and/or can be in communication with an autonomous navigation system included in a robotics device or system. While examples are described herein using autonomous driving systems, autonomous navigation systems, and/or autonomous vehicles for illustrative purposes, one of ordinary skill will appreciate the point map registration system 300 and related techniques described herein can be included in and performed by any other system or device for determining registration between point maps.

The point map registration system 300 can be used to estimate the location of the tracking object relative to a reference point map using point detections from radars, using radar images, a combination thereof, and/or using other information. In one illustrative example, the point map registration system 300 can estimate the positions and/or sizes of target vehicles detected on a road using wheel keypoint detections and corresponding vehicle type classifications from cameras, point detections from radars, and, optionally, object detections from imaging radars. As described in more detail below, the point map registration system 300 can apply any combination of one or more of a camera-based object-type likelihood filter, a target position estimation technique for object (e.g., vehicle or other object) dimension estimation (e.g., based on observed wheel keypoint locations), a radar-based length estimation technique, and/or imaging radar-based object detections, and can implement an estimation model to track the best estimate of the size (e.g., length and/or other size dimension) of an object using measurements provided by map-based size determination, the radar-based size estimation, and/or the imaging radar detections.

The point map registration system 300 includes various components, including one or more cameras 302, a feature detection engine 304, a line generation engine 306, a correspondence engine 308, and a transformation engine 310. The components of the point map registration system 300 can include software, hardware, or both. For example, in some implementations, the components of the point map registration system 300 can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the computing device implementing the point map registration system 300.

While the point map registration system 300 is shown to include certain components, one of ordinary skill will appreciate that the point map registration system 300 can include more or fewer components than those shown in FIG. 3. For example, the point map registration system 300 can include, or can be part of a computing device or object that includes, one or more input devices and one or more output devices (not shown). In some implementations, the point map registration system 300 may also include, or can be part of a computing device (e.g., computing system 1300 of FIG. 3) that includes, one or more memory devices (e.g., one or more random access memory (RAM) components, read-only memory (ROM) components, cache memory components, buffer components, database components, and/or other memory devices), one or more processing devices (e.g., one or more CPUs, GPUs, and/or other processing devices) in communication with and/or electrically connected to the one or more memory devices, one or more wireless interfaces (e.g., including one or more transceivers and a baseband processor for each wireless interface) for performing wireless communications, one or more wired interfaces (e.g., a serial interface such as a universal serial bus (USB) input, a lightning connector, and/or other wired interface) for performing communications over one or more hardwired connections, and/or other components.

As noted above, the point map registration system 300 can be implemented by and/or included in a computing device or other object. In some cases, multiple computing devices can be used to implement the point map registration system 300. For example, a computing device used to implement the point map registration system 300 can include a computer or multiple computers that are part of a device or object, such as a vehicle, a robotic device, a surveillance system, and/or any other computing device or object with the resource capabilities to perform the techniques described herein. In some implementations, the point map registration system 300 can be integrated with (e.g., integrated into the software, added as one or more plug-ins, included as one or more library functions, or otherwise integrated with) one or more software applications, such as an autonomous driving or navigation software application or suite of software applications. The one or more software applications can be installed on the computing device or object implementing the point map registration system 300.

The one or more cameras 302 of the point map registration system 300 can capture one or more images 303. In some cases, the one or more cameras 302 can include multiple cameras. For example, an autonomous vehicle including the point map registration system 300 can have a camera or multiple cameras on the front of the vehicle, a camera or multiple cameras on the back of the vehicle, a camera or multiple cameras on each side of the vehicle, and/or other cameras. In another example, a robotic device including the point map registration system 300 can include multiple cameras on various parts of the robotics device. In another example, aviation device including the point map registration system 300 can include multiple cameras on different parts of the aviation device.

The one or more images 303 can include still images or video frames. The one or more images 303 each contain images of a scene. An example of an image 305 is shown in FIG. 3. The image 305 illustrates an example of an image captured by a camera of a tracking vehicle, including multiple target vehicles. When image frames are captured, the image frames can be part of one or more video sequences. In some cases, the images captured by the one or more cameras 302 can be stored in a storage device (not shown), and the one or more images 303 can be retrieved or otherwise obtained from the storage device. In some implementations, a reference point map 307 can be obtained from the storage device. In some examples, the reference point map 307 can correspond to a HD road map, a map of a geographic area, or the like. The one or more images 303 can be raster images composed of pixels (or voxels) optionally with a depth map, vector images composed of vectors or polygons, or a combination thereof. The images 303 may include one or more two-dimensional representations of a scene along one or more planes (e.g., a plane in a horizontal or x-direction and a plane in a vertical or y-direction), or one or more three dimensional representations of the scene.

The feature detection engine 304 can obtain and process the one or more images 303 to detect and/or track one or more objects in the one or more images 303. The feature detection engine 304 can output objects as detected and tracked objects. The feature detection engine 304 can determine a classification (referred to as a class) or category of each object detected in an image. For example, the feature detection engine 304 can determine a lane line classification for the lane lines 311. In some cases, the feature detection engine 304 can output multiple classes for a detected object, along with a confidence score indicating a confidence that the object belongs to each of the classes (e.g., a confidence score of 0.85 that the object is a lane line, a confidence score of 0.14 that the object is a center divider, and a confidence score of 0.01 that the object is a motorcycle).

In some cases, the feature detection engine 304 can output positions of objects detected in a sensed point map 331. For example, the feature detection engine 304 can detect and output points (e.g., spatial positions in a 3D coordinate system) corresponding to the lane lines 311. In some cases, one or more classification determined by the feature detection engine 304 can be used to identify specific objects (e.g., lane lines 311) for additional processing (e.g., registration). In some cases, the sensed point map 331 may be incomplete (e.g., due to obstructions by objects in the scene). In some examples, by registering the sensed point map 331 to the reference point map 307, the missing information in the sensed point map 331 can be supplemented by the reference point map 307 (e.g., the obstructed portions of the environment may be present in the reference road map 307).

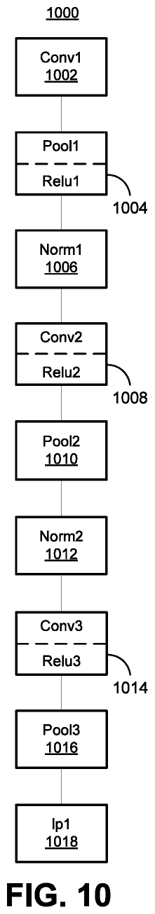

Any suitable object detection and/or classification technique can be performed by the feature detection engine 304. In some cases, the feature detection engine 304 can use a machine learning based object detector, such as using one or more neural networks. For instance, a deep learning-based object detector can be used to detect and classify objects in the one or more images 303. In one illustrative example, a Cifar-10 neural network based detector can be used to perform object classification to classify objects. In some cases, the Cifar-10 detector can be trained to classify only certain objects, such as lane lines only. Further details of the Cifar-10 detector are described below with respect to FIG. 10.

Another illustrative example of a deep learning based detector is a fast single-shot object detector (SSD) including a neural network and that can be applied for multiple object categories. A feature of the SSD model is the use of multi-scale convolutional bounding box outputs attached to multiple feature maps at the top of the neural network. Such a representation allows the SSD to efficiently model diverse bounding box shapes. It has been demonstrated that, given the same VGG-16 base architecture, SSD compares favorably to its state-of-the-art object detector counterparts in terms of both accuracy and speed. An SSD deep learning detector is described in more detail in K. Simonyan and A. Zisserman, “Very deep convolutional networks for large-scale image recognition,” CoRR, abs/1309.1556, 79014, which is hereby incorporated by reference in its entirety for all purposes. Further details of the SSD detector are described below with respect to FIG. 11A through FIG. 11C.

Another illustrative example of a deep learning-based detector that can be used to detect and classify objects in the one or more images 303 includes the You only look once (YOLO) detector. The YOLO detector, when run on a Titan X, processes images at 40-90 fps with a mAP of 78.6% (based on VOC 2007). A YOLO deep learning detector is described in more detail in J. Redmon, S. Divvala, R. Girshick, and A. Farhadi, “You only look once: Unified, real-time object detection,” arXiv preprint arXiv:1506.02640, 2015, which is hereby incorporated by reference in its entirety for all purposes. Further details of the YOLO detector are described below with respect to FIG. 12A through FIG. 12C. While the Cifar-10, SSD, and YOLO detectors are provided as illustrative examples of deep learning-based object detectors, one of ordinary skill will appreciate that any other suitable object detection and classification can be performed by the feature detection engine 304.

FIG. 4A and FIG. 4B are diagrams illustrating an example reference point map 407 (e.g., reference point map 307 of FIG. 3) and an example sensed point map 431 generated based on one or more images (e.g., sensed point map 331 of FIG. 3). In the illustration 400 of FIG. 4A, the points of the reference point map 407 have the appearance of thin lines and the points of the sensed point map 431 have the appearance of thick lines. FIG. 4B illustrates a subset 450 of the points included in the reference point map 407 and sensed point map 431 with a greater visual emphasis of the individual points. In the illustration of FIG. 4B, the reference point map 407 includes small ovals corresponding to points in the reference point map 407. Similarly, the sensed point map 431 depicts larger ovals representing points in the sensed point map 431. The depiction of FIG. 4B is provided for understanding the contents of the point maps 407, 431. Although the points of the point maps 407, 431 are illustrated as ovals in FIG. 4B, it should be understood that each oval can represent a value, such as a 3D position value for each point.

Returning to FIG. 3, the line generation engine 306 can generate groupings of points in point maps (e.g., sensed point map 331, reference point map 307) into point groups. As an illustrative example, the groups generated by line generation engine 306 semantically represent lines. In some cases, other groupings based on different semantic representations can be used without departing from the scope of the present disclosure.

As illustrated in FIG. 3, the line generation engine 306 can obtain a sensed point map 331 output from the feature detection engine 304. In some cases, the line generation engine 306 can also obtain a reference point map 307. In some examples, groups can be generated by determining whether a distance between a particular point and a nearest adjacent point to the particular point is below a distance threshold. In one illustrative example, points can be grouped together into point groupings by determining whether the Euclidian distance between a point and another adjacent point is smaller than 0.15 meter (m). In some cases, the line generation engine 306 can perform grouping for every point in a given point map and generate a plurality of point group representations of the corresponding to the lines in the point maps (e.g., reference point map 307, sensed point map 331). As used herein, point groupings representing lines are also referred to as line representations for a point map. In the illustrated example of FIG. 3, the line generation engine 306 can output a sensed line representation 309 for the sensed point map 331 and a reference line representation 313 for the reference point map 307. In some implementations (not shown), the reference point map 307 itself can include line representations, and the point map registration system 300 may be able to utilize the line representation of the reference point map 307 stored in storage. In some cases, the stored line representation of the reference point map 307 can be used instead of and/or in combination with the reference line representation 313 of the reference point map 307 in the line generation engine 306.

In some cases, the line generation engine 306 can generate groupings that include curved line segments, as long as the threshold criteria for grouping points into point groups is met. In some cases, different and/or additional criteria can be used during generation of the line representations 309, 313. For example, in some cases, a linearity threshold may be utilized to distinguish intersecting lines into separate groupings within the 309, 313. In another illustrative example, the spatial position of a line generated by the line generation engine 306 can be compared with a road plane (e.g., as described with respect to FIG. 2A). Other criteria may also be used to distinguish lane lines within the line representations, 309, 313 without departing from the scope of the present disclosure.

Each of the line representations 309, 313 may include a different number of groupings (e.g., a different number of lines). For example, the sensed line representation 309 for the sensed point map 331 can include M elements, where M is an integer. Equation [1] below illustrates a sensed line representation 309 including M elements:

$$\ddot{U} \ddot{U} , \ddot{U} , … , \ddot{U} \qquad [ 1 ]$$

Similarly, the reference line representation 313 for the reference point map 307 can include N elements, where N is and integer. Equation [2] below illustrates a reference line representation 313 including N elements:

$$\ddot{U} \ddot{U} , \ddot{U} , … , \ddot{U} \qquad [ 2 ]$$

In some cases, the sensed line representation 309 can include more point groupings than the reference line representation 313 (e.g., M>N). In some cases, the reference line representation 313 can include more point groupings than the sensed line representation 309 (e.g., M<N). In some examples, the line representations 309, 313 can include equal numbers of point groupings (e.g., M=N).

Referring to FIG. 4B, an example reference line 413 can provide an example of a line determined by the line generation engine 306 and included in the reference line representation 313. Similarly, example sensed line 409 can provide an example of a line determined by the line generation engine 306 and included in the sensed line representation 309.

Returning to FIG. 3, in one illustrative example, correspondence engine 308 can obtain M line representations included in the sensed lined representations 309 and N line representations included in the reference line representations 313 from the line generation engine 306. In some implementations, the correspondence engine 308 can determine a correspondence between lines in the sensed line representation 309 and lines in the reference line representation 313.

In some cases, a dynamic time-warping (DTW) algorithm can be used to determine the correspondence between individual lines (e.g., individual point groupings) in the sensed line representation 309 and corresponding individual lines in the reference line representation 313. In some aspects, the DTW algorithm can be used to compare sequential data from different datasets, where the sequential ordering between the datasets is consistent. In some cases, the sequential ordering can correspond to time. In one illustrative example, the DTW algorithm can be used to compare audio to determine whether audio data corresponds to the same word. In such cases, the audio data can be stored as a time sequence (e.g., sequential sampled data captured by a microphone). Although time can provide a convenient sequential relationship for some types of data, the DTW algorithm can also be used with other types of data where the data in datasets being compared have a comparable sequential ordering.

In some examples, such as the case of lane lines on a road, a sequential data order can be based on the direction of travel of the vehicle (e.g., the tracking vehicle 102 of FIG. 1). For example, the individual points of each line in the line representations 309, 313 can be sequentially ordered based on a position along an axis. For example, the axis used for sequentially ordering the points of a line can be an axis parallel to the direction of motion of a tracking vehicle, an axis parallel to the optical axis of a camera capturing images of the road, or the like. The individual point groupings of the sensed line representation 309 can be identified by an index i where each point grouping Ü can represent a line including individual points P as shown in Equation [3] below:

$$\ddot{U} \tilde{\dot{U}} , \tilde{\dot{U}} , … , \tilde{\dot{U}} \qquad [ 3 ]$$

In some cases, the reference line representation 313 of the reference point map 307 can also be sequentially ordered relative to the same axis orientation used to sequence the points in the sensed line representation 309. In some cases, the reference point map can include information about orientation (e.g., relative to four cardinal directions, geographic coordinates, or the like). The individual point groupings of the reference line representation 313 can be identified by an index j where each point grouping Ü can represent a line including individual points P as shown in Equation [4] below:

$$\ddot{U} \tilde{\dot{U}} , \tilde{\dot{U}} , … , \tilde{\dot{U}} \qquad [ 4 ]$$

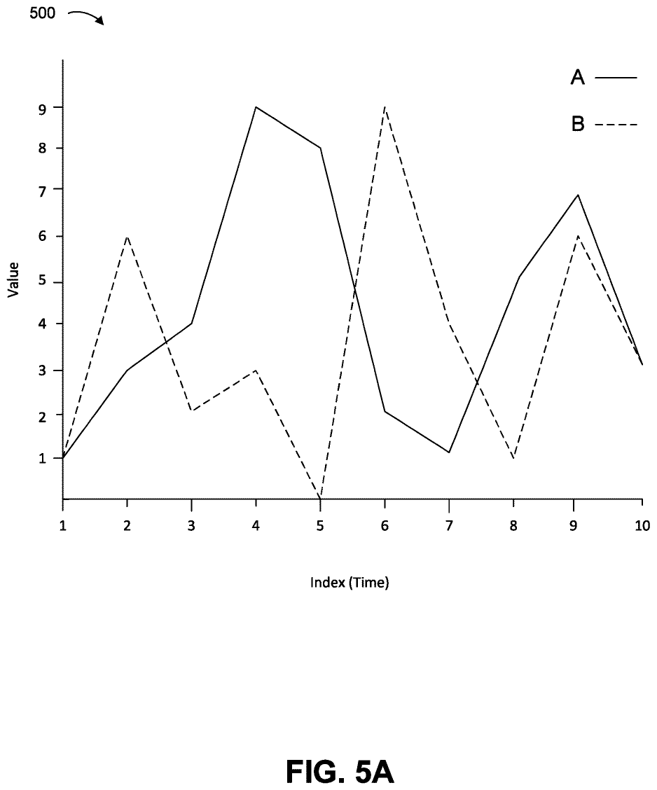

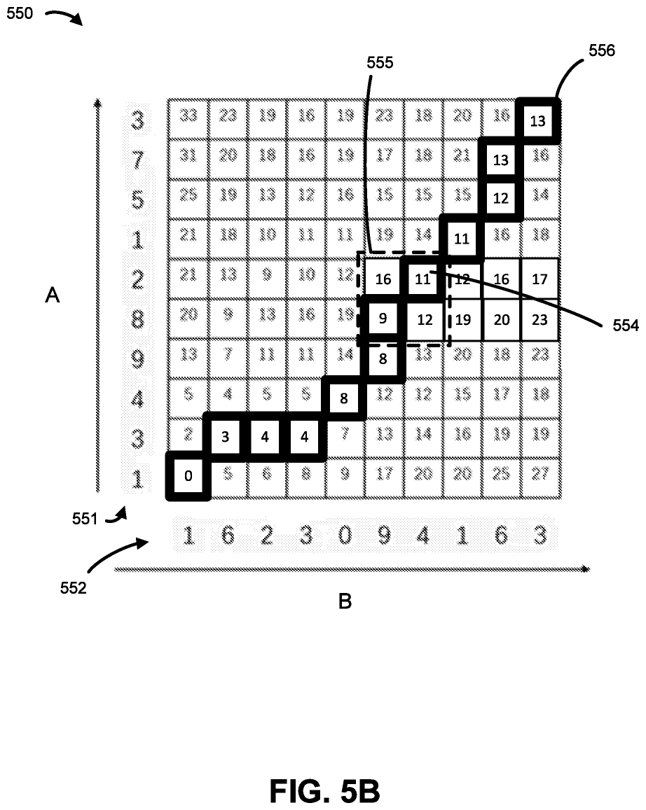

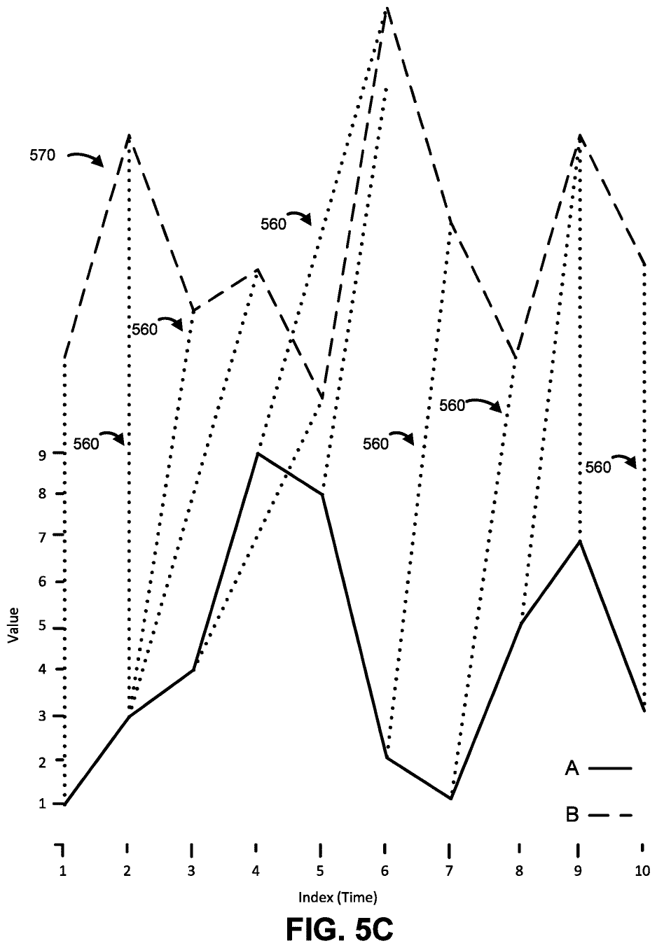

FIG. 5A and FIG. 5B illustrate an example DTW algorithm comparison of two data sequences. FIG. 5A illustrates a data plot 500 of data sequence A and data sequence B. In the illustration of FIG. 5A, the horizontal axis represents an index representing the sequence order of data points. In some cases, the horizontal axis can represent time. In some cases, index can correspond to the sequential ordering generated by the correspondence engine 308 of FIG. 3. The vertical axis of FIG. 5A illustrates a data value, which is shown without units. In one illustrative example of determining correspondence between line representations (e.g., line representations 309, 313 of FIG. 3) of point maps (e.g., reference point map 307, sensed point map 331 of FIG. 3) the value can correspond to positions of the points of a line segment, distance of the points of the line segment from an origin position (e.g., the location of the one or more cameras 302 used to capture the one or more images 303 of FIG. 3), or the like. In some cases, the DTW algorithm can compute a DTW “distance” between two data sequences.

Referring to FIG. 5B, a DTW distance calculation matrix 550 for calculating the DTW distance between data sequence A and data sequence B is shown. As illustrated the values 551 of sequence A are listed next to each row of the matrix 550, according to the index order, starting with the first value of “1” at the bottom row of the matrix 550 and ending with the final value of “3” at the top row of the matrix 550. Similarly, the values 552 of sequence B are listed below each column of the matrix 550, starting with the first value “1” of the sequence at the left-most column and ending with the final value of “3” at the right-most column of the matrix 550. As illustrated, the each of the cells of the matrix 550 include a distance value calculated for a pair of points in the two sequences A and B. component based on the values of the series in the corresponding row/column. The values in each of the cells of matrix 550 can be determined according to Equation [1] below:

$${}^{′} O \text{?} \ddot{O} \ddot{O} min {}^{′} O \text{?} 1 , \text{?} 1 , {}^{′} O \text{?} 1 , \text{?} , {}^{′} O \text{?} , \text{?} 1 \qquad [ 5 ]$$

Where [symbol] is the index for the sequence A and [symbol] is the index for the sequence B, \dot{O} [symbol] is the distance corresponding to a pair of values ö and ö, ö ö is the modulus of ö and ö and the min( ) function takes the value of the smallest of three neighboring distance measurements.

Applying Equation [5] to the cell 554 gives \dot{O} 6, 7=|2 4|+min (9, 16, 12)=2+9=11. In the example of FIG. 5B, the final DTW distance 556 calculated between sequence A and sequence B is equal to 13. The cells included in the distance calculation for the cell 554 function are contained within the dashed line 555.

In addition to determining a line-to-line correspondence, the DTW algorithm can also be used to determine point-to-point correspondence between points of the sequences being compared. FIG. 5C illustrates an example 570 of the point-to-point correspondence for sequence A and sequence B as discussed with respect to FIG. 5A and FIG. 5B. In the example of FIG. 5C, the point-to-point correspondences are illustrated by the dark bolded outlined cells. The point-to-point correspondence can be determined based on the minimum DTW distance between the points of sequence A and sequence B. FIG. 5C illustrates the correspondences 560 (e.g., dotted lines) illustrated the correspondences identified with the dark bolded outlined cells of FIG. 5B. In some cases, the mapping between points of the two sequences may not be 1:1. For example, the point of sequence A index=2 can correspond to the points of sequence B with index=2, 3, and 4. In some cases, the DTW algorithm can determine point-to-point correspondence for points within every compared sequence (e.g., for the M×N calculated DTW distances).

In some cases, for the purposes of registration, point-to-point correspondence between point maps (e.g., reference point map 307, sensed point map 331 of FIG. 3) can be determined by first determining line-to-line correspondence. For example, the line-to-line correspondence can be determined based on mutual minimum distance between lines, DTW distance, or any combination thereof. In some cases, point-to-point correspondence can be generated during calculation of the line-to-line correspondence. In one illustrative example, the point-to-point correspondence can be determined based on DTW distance (e.g., based on the bold outlined cells of FIG. 5B). In some cases, point-to-point correspondences can be calculated using other suitable techniques as constrained by the line-to-line correspondence. In some cases, the correspondence engine 308 can output the point-to-point correspondences to the transformation engine 310.

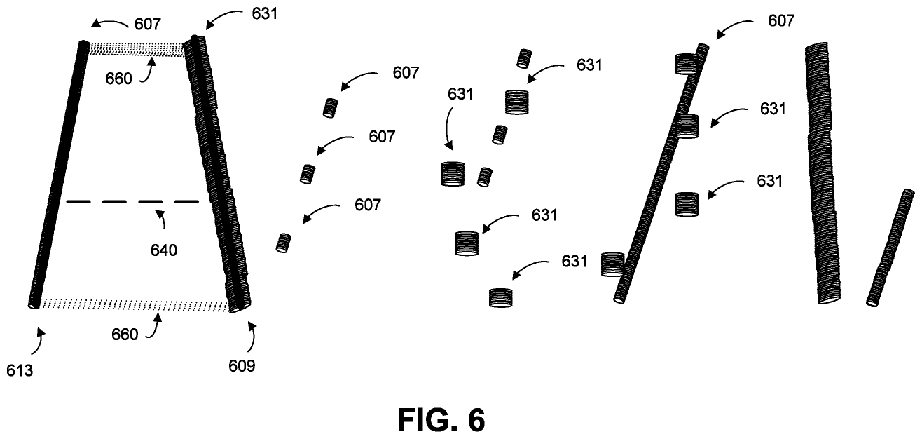

FIG. 6 illustrates an example of line-to-line and point-to-point correspondence that can be determined by the correspondence engine 308 of FIG. 3. In the illustration of FIG. 6, reference point map 607 can correspond to reference point map 407 of FIG. 4B, sensed point map 631 can correspond to sensed point map 431 of FIG. 4B, sensed line 609 can correspond to sensed line 409 of FIG. 4B, and reference line 613 can correspond to reference line 413 of FIG. 4B. A line correspondence between the sensed line 609 and the reference line 613 is illustrated as a thick dashed line 640. A plurality of point-to-point correspondences 660 are illustrated by dotted lines. The point-to-point correspondences 660 can correspond to the correspondences 560 illustrated in FIG. 5C. For the purposes of illustration, the point-to-point correspondences 660 are shown near the distal ends of the sensed line 609 and the reference line 613. However, it should be understood that point-to-point correspondences for every point in each of the lines can be determined as described above with respect to the correspondence engine 308 of FIG. 3.

Returning to FIG. 3, transformation engine 310 can determine a transformation for transforming the sensed point map 331 to align with the reference point map 307. As noted above, the transformation engine 310 can obtain a point-to-point correspondence determined by the correspondence engine 308. In one illustrative example, the transformation engine 310 can utilize any suitable calculation for determining a transformation to align the sensed point map 331 and the reference point map 307. For example a least squares technique can be used to generate a transformation between the sensed point map 331 and the reference point map 307. In some cases, a least squares technique can include a transformation that minimizes a least squares distance error between the sensed point map 331 and the reference point map 307. In one illustrative example, a transformation matrix can be generated using a least squares technique described in K. S. Arun, T. S. Huang, and S. D. Blostein, “Least-Squares Fitting of Two 3-D Point Sets,” IEEE Transactions on pattern analysis and machine intelligence, September 1998, which is hereby incorporated by reference in its entirety for all purposes.

For example, a transformation for a point \ddot{ω} in sensed point map 331 is described with respect to Equation [6] below:

$$\ddot{ω} \ddot{ω} {}^{″} Y = \ddot{ω} {}^{′} Y \dot{o} \qquad [ 6 ]$$

Where \ddot{ω} is the translation of point \ddot{ω}, γ is a translation matrix including rotational parameters 'γ and translation parameters ò. An example of the rotational parameters is shown in Equation [7] below:

$$= \vert \begin{matrix}1 & 0 & 0 & cos {\vert}^{\times } & 0 & sin {\vert}^{\times } & cos \vert & sin \vert & 0 \\ 0 & cos {\vert}^{\to } & sin {\vert}^{\to } & 0 & 1 & 0 & sin \vert & cos \vert & 0 \\ 0 & sin {\vert}^{\to } & cos {\vert}^{\to } & sin {\vert}^{\times } & 0 & cos {\vert}^{\times } & 0 & 0 & 1\end{matrix} \qquad [ 7 ]$$

In the above equation, α is the yaw (horizontal rotation), β is the pitch (up-and-down rotation), and γ is the roll (side-to-side rotation). The pitch, roll, and yaw can be conceptualized as the yaw being the horizontal rotation relative to the ground (e.g., left-to-right relative to the horizontal axis), the pitch being vertical rotation relative to the ground (e.g., up and down relative to the horizontal axis), and the roll being side-to-side rotation relative to the horizon (e.g., side-to-side relative to the horizontal axis). The translation vector t can be expressed as shown in Equation (6):

$$\text{?} \begin{matrix}\ddot{ω} \\ \ddot{ω} \\ \ddot{ω}\end{matrix} \qquad [ 8 ]$$

Where \ddot{ω}, \ddot{ω}, and \ddot{ω} are translation components in X, Y, and Z coordinates of a Euclidian geometry, respectively.

In some cases, a translated sensed point map 370 can be generated by the transformation engine 310. In some examples, the translated sensed point map 370 can be provided to the correspondence engine 308 and correspondence between the 370 and the reference point map 307 can be determined. In some examples, determining correspondence by the correspondence engine 308 and determining a translation by the transformation engine 310 can be iterated until a convergence is reached or a maximum number of iterations occurs.

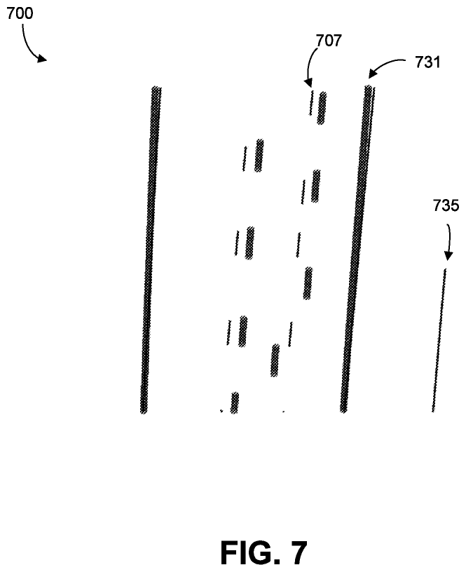

FIG. 7 illustrates an example point map registration 700 that can be performed by the point map registration system 300 of FIG. 3. In the illustrated example of FIG. 7, a sensed point map 731 (represented by thick lines) generated based on an image (e.g., sensed point map 331 of FIG. 3) is transformed based on a transformation determined by the point map registration system 300 of FIG. 3. In the illustrated example, the sensed point map 731 is aligned with a reference point map 707 (represented by thin lines). As illustrated, the alignment of the sensed point map 731 with the reference point map 707 (e.g., reference point map 307 of FIG. 3) can be improved relative to the alignment illustrated in FIG. 2C (e.g., based on an ICP algorithm). As noted above, leveraging the semantic information that groups of points in close proximity to one another in the point maps 707, 731 can correspond to lines (e.g., lane lines), the correspondence between the point maps 707, 731, can be improved. For example, disparities in length between lines in the sensed point map 731 and the reference point map 707 can result in larger DTW distance values, thereby leveraging the length of the lines as additional semantic information. In addition, as illustrated, mismatched points 735 included in the reference point map 707 may be determined by the point map registration system 300 (e.g., by correspondence engine 308 of FIG. 3) to have no corresponding points in the sensed point map 731 (e.g., a line formed by grouping mismatched points 735 does not match any of the lines in the sensed point map 731). Accordingly, the mismatched points 735 can be excluded from the transformation calculation by the transformation engine 310.

Accordingly, based on the above, it should be understood that the point map registration systems and techniques described herein can improve point map registration. For example, correspondence can be determined between point groupings representing lines in the point maps (e.g., lane lines). By comparison, a pure point-to-point algorithm (e.g., an ICP algorithm) may ignore the semantic information that particular points of the point maps correspond to lane lines. In some cases, the resulting alignment from point-to-point registration may be relatively rough and/or susceptible to errors due to mismatched points between the reference point map (e.g., reference point map 307 of FIG. 3) and a sensed point map (e.g., sensed point map 331 of FIG. 3) determined based on an image captured by a camera (e.g., one or more cameras 302 of FIG. 3). In some cases, the systems and techniques described herein can utilize directional information to sequentially order the points included in a point grouping (e.g., the points of a particular lane line segment) relative to an axis. In some cases, a DTW algorithm can be used to determine correspondence between the sequentially ordered point groupings in the reference point map and the point map generated based on the captured image (also referred to herein as the sensed point map). In some cases, by determining a line-to-line correspondence in addition to a point-to-point correspondence (e.g., based on the determined line to line correspondence), the point-to-point correspondence can be improved. Based on the improved correspondence, a transformation can be determined by the systems and techniques that provides improved alignment between the reference point map and the point map generated based on the captured image.

In some examples, the alignment between the reference point map and the mpoint map generated based on the captured image can be used to determine a localization of a tracking object. In one illustrative example, the localization can be used to determine at least one or more of a lane position of the tracking object, a direction of travel, lane positions of one or more target objects, or the like. In some implementations, the localization can an autonomous navigation system can perform one or more navigation operations based on the localization. For example, the autonomous navigation can generate a notification (e.g., generate a visual, audio, and/or tactile notification, generating and/or transmit a message, or the like), perform motion planning (e.g., adjusting speed, collision avoidance, changing a driving lane, or the like), navigation planning (e.g., adjusting a travel route), and/or a any other suitable operation based on the localization.

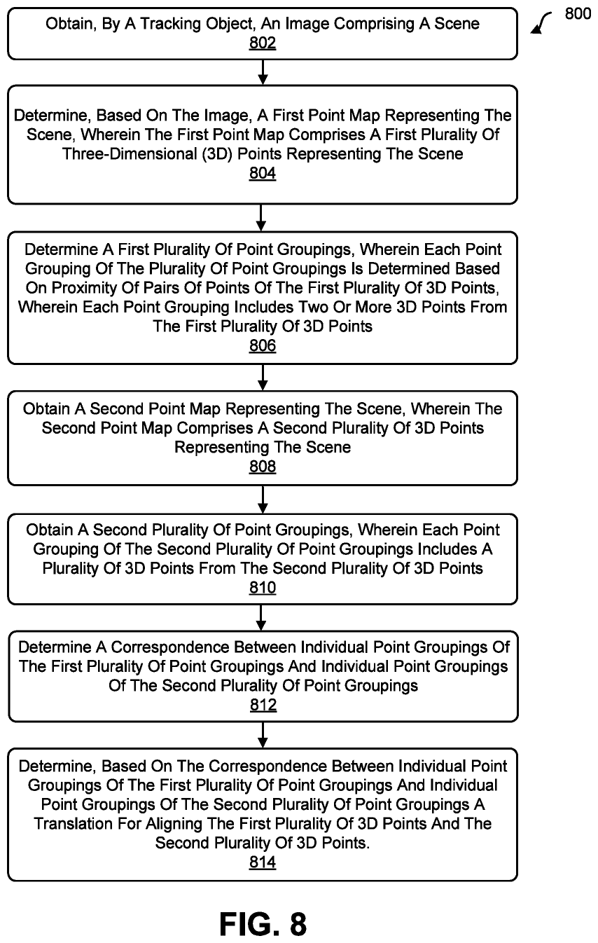

FIG. 8 is a flow diagram illustrating an example of a process 800 for performing point map registration, according to some aspects of the disclosed technology. In some implementations, the process 800 can include, at block 802, obtaining (e.g., by one or more cameras 302 of FIG. 3) an image (e.g., one or more images 303 of FIG. 3) comprising a scene.

At block 804, the process 800 can include determining (e.g., by feature detection engine 304 of FIG. 3), based on the image, a first point map representing the scene (e.g., 431 of FIG. 4A and FIG. 4B. In some cases, the first point map includes a first plurality of 3D points representing the scene.

At block 806, the process 800 can include determining (e.g., by line generation engine 306 of FIG. 3) a first plurality of point groupings (e.g., sensed lines 409 of FIG. 4A and FIG. 4B). In some examples, each point grouping of the first plurality of point groupings is determined based on proximity of pairs of points of the first plurality of 3D points. In some aspects, each point grouping includes two or more 3D points from the first plurality of 3D points. In some examples, individual point groupings of the first plurality of point groupings correspond to lines in the image.

In some examples, the process 800 includes determining, for a first point of the first plurality of 3D points, that a first Euclidian distance between the first point of the first plurality of 3D points and a second point of the first plurality of 3D points is less than a threshold distance. In some cases, the second point of the first plurality of 3D points is adjacent to the first point of the first plurality of 3D points and grouping, based on determining that first Euclidian distance between the first point of the first plurality of 3D points and the second point of the first plurality of 3D points is less than the threshold distance, the first point and the second point into a first point grouping of the first plurality of point groupings. In some examples, the process 800 includes determining, for the second point of the first plurality of 3D points, that a second Euclidian distance between the second point of the first plurality of 3D points and a third point of the first plurality of 3D points is greater than the threshold distance and based on determining that the second Euclidian distance between the second point of the first plurality of 3D points and the third point of the first plurality of 3D points is greater than the threshold distance, excluding the third point of the first plurality of 3D points from the first point grouping of the first plurality of point groupings.

At block 808, the process 800 can include obtaining a second point map representing the scene (e.g., reference point map 229 of FIG. 2B and FIG. 2C, reference point map 407 of FIG. 4A and FIG. 4B). In some examples, the second point map includes a second plurality of 3D points representing the scene. In some cases, the reference point map includes a reference point map. In some cases, the reference point map includes a HD reference point map. In some aspects, the reference point map is obtained from a reference map service.

At block 810, the process 800 can include obtaining a second plurality of point groupings (e.g., reference lines 413 of FIG. 4A and FIG. 4B). In some cases, each point grouping of the second plurality of point groupings includes a plurality of 3D points from the second plurality of 3D points. In some examples, the process 800 includes determining, based on determining correspondence between a first point grouping of the first plurality of point groupings and a second point grouping of the second plurality of point groupings, a correspondence between individual points of the first point grouping of the first plurality of point groupings and individual points of the second point grouping of the second plurality of point groupings.

In some examples, the process 800 includes applying a sequential ordering for points included in each point grouping of the first plurality of point groupings based on a respective position of each pixel included in each respective point grouping of the first plurality of point groupings along an axis and applying the sequential ordering for points included in each point grouping of the second plurality of point groupings based on a respective position of each pixel included in each respective point grouping of the second plurality of point groupings along the axis. In some cases, the axis corresponds to at least one or more of a direction of motion of a tracking object or an optical axis associated with the image.

At block 812, the process 800 can include determining a correspondence (e.g., by correspondence engine 308 of FIG. 3) between individual point groupings of the first plurality of point groupings and individual point groupings of the second plurality of point groupings. In some cases, determining correspondence between individual point groupings of the first plurality of point groupings and individual point groupings of the second plurality of point groupings includes determining at least one or more of the individual point groupings of the first plurality of point groupings or the individual point groupings of the second plurality of point groupings does not have a corresponding individual point grouping.

In some examples, the process 800 includes determining dynamic time warping distances between each point grouping of the first plurality of point groupings and each point grouping of the second plurality of point groupings and determining, based on the dynamic time warping distances, a correspondence between individual point groupings of the first plurality of point groupings and individual point groupings of the second plurality of point groupings.

At block 814, the process 800 can include determining (e.g., by transformation engine 310 of FIG. 3), based on the correspondence between individual point groupings of the first plurality of point groupings and individual point groupings of the second plurality of point groupings, an alignment transformation for aligning the first plurality of 3D points and the second plurality of 3D points.

In some examples, the process 800 includes applying the alignment transformation to one of the first plurality of 3D points representing the scene or the second plurality of 3D points to generate a transformed first plurality of 3D points and determining correspondence between the transformed first plurality of 3D points and the other of the first plurality of 3D points or the second plurality of 3D points.

In some examples, process 800 includes aligning, based on the alignment transformation, the first plurality of 3D points and the second plurality of 3D points and determining, based on aligning the first plurality of 3D points and the second plurality of 3D points, a localization of a tracking object relative to the second point map. In some examples, the second point map includes a reference point map. In some examples, the process 800 includes performing, based on the localization, a navigation operation.

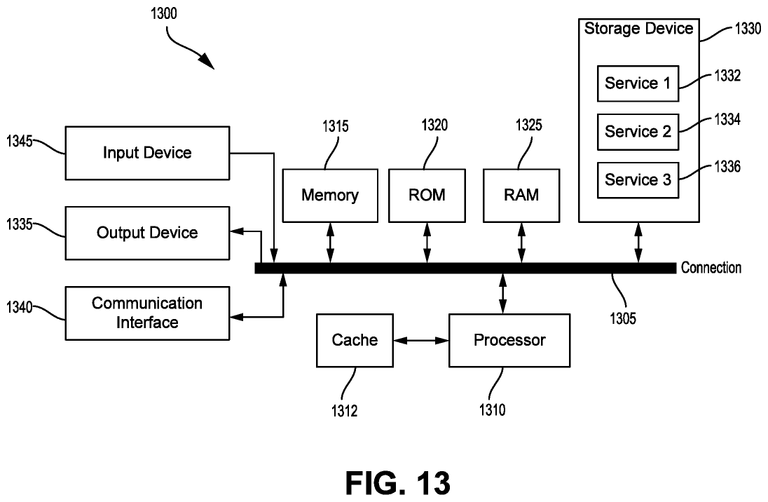

In some examples, the processes described herein (e.g., process 800 and/or other process described herein) may be performed by a computing device or apparatus (e.g., a vehicle computer system). In one example, the process 800 can be performed by the point map registration system 300 shown in FIG. 3. In another example, the process 800 can be performed by a computing device with the computing system 1300 shown in FIG. 13. For instance, a vehicle with the computing architecture shown in FIG. 13 can include the components of point map registration system 300 shown in FIG. 3 and can implement the operations of process 800 shown in FIG. 8.

The process 800 is illustrated as a logical flow diagram, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 800 and/or other process described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

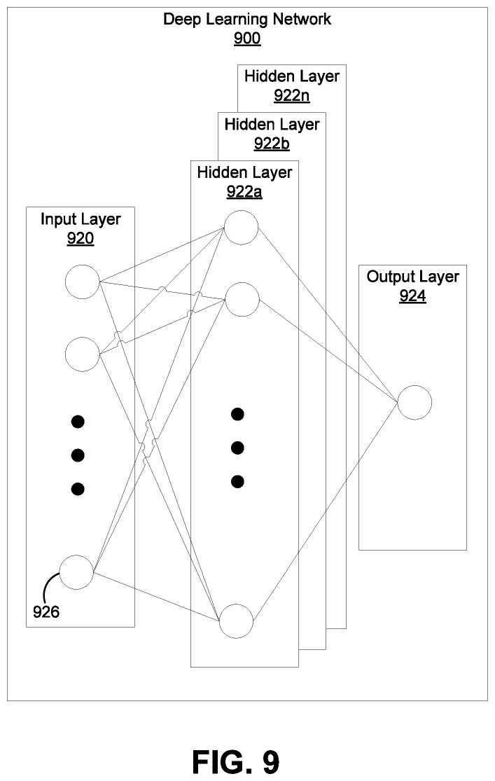

As noted above, the object detection and tracking system can use a machine-learning based object detector (e.g., based on a deep neural network) to perform object detection. FIG. 9 is an illustrative example of a deep neural network 900 that can be used to perform object detection on an image containing a target object, such as lane lines 311 located in image 303 of FIG. 3, as discussed above. Deep neural network 900 includes an input layer 920 that is configured to ingest input data, such as pre-processed (scaled) sub-images that contain a target object for which detection is to be performed. In one illustrative example, the input layer 920 can include data representing the pixels of an input image or video frame. The neural network 900 includes multiple hidden layers 922a, 922b, through 922n. The hidden layers 922a, 922b, through 922n include “n” number of hidden layers, where “n” is an integer greater than or equal to one. The number of hidden layers can be made to include as many layers as needed for the given application. The neural network 900 further includes an output layer 924 that provides an output resulting from the processing performed by the hidden layers 922a, 922b, through 922n. In one illustrative example, the output layer 924 can provide a classification for an object in an image or input video frame. The classification can include a class identifying the type of object (e.g., a person, a dog, a cat, or other object).

The neural network 900 is a multi-layer neural network of interconnected nodes. Each node can represent a piece of information. Information associated with the nodes is shared among the different layers and each layer retains information as information is processed. In some cases, the neural network 900 can include a feed-forward network, in which case there are no feedback connections where outputs of the network are fed back into itself. In some cases, the neural network 900 can include a recurrent neural network, which can have loops that allow information to be carried across nodes while reading in input.

Information can be exchanged between nodes through node-to-node interconnections between the various layers. Nodes of the input layer 920 can activate a set of nodes in the first hidden layer 922a. For example, as shown, each of the input nodes of the input layer 920 is connected to each of the nodes of the first hidden layer 922a. The nodes of the hidden layers 922a, 922b, through 922n can transform the information of each input node by applying activation functions to this information. The information derived from the transformation can then be passed to and can activate the nodes of the next hidden layer 922b, which can perform their own designated functions. Example functions include convolutional, up-sampling, data transformation, and/or any other suitable functions. The output of the hidden layer 922b can then activate nodes of the next hidden layer, and so on. The output of the last hidden layer 922n can activate one or more nodes of the output layer 924, at which an output is provided. In some cases, while nodes (e.g., node 926) in the neural network 900 are shown as having multiple output lines, a node has a single output and all lines shown as being output from a node represent the same output value.

In some cases, each node or interconnection between nodes can have a weight that is a set of parameters derived from the training of the neural network 900. Once the neural network 900 is trained, it can be referred to as a trained neural network, which can be used to classify one or more objects. For example, an interconnection between nodes can represent a piece of information learned about the interconnected nodes. The interconnection can have a tunable numeric weight that can be tuned (e.g., based on a training dataset), allowing the neural network 900 to be adaptive to inputs and able to learn as more and more data is processed.

The neural network 900 is pre-trained to process the features from the data in the input layer 920 using the different hidden layers 922a, 922b, through 922n in order to provide the output through the output layer 924. In an example in which the neural network 900 is used to identify objects (e.g., lane lines) in images, the neural network 900 can be trained using training data that includes both images and labels. For instance, training images can be input into the network, with each training image having a label indicating the classes of the one or more objects in each image (basically, indicating to the network what the objects are and what features they have). In one illustrative example, a training image can include an image of a number 2, in which case the label for the image can be [0 0 1 0 0 0 0 0 0 0].

In some cases, the neural network 900 can adjust the weights of the nodes using a training process called backpropagation. Backpropagation can include a forward pass, a loss function, a backward pass, and a weight update. The forward pass, loss function, backward pass, and parameter update is performed for one training iteration. The process can be repeated for a certain number of iterations for each set of training images until the neural network 900 is trained well enough so that the weights of the layers are accurately tuned.

For the example of identifying objects in images, the forward pass can include passing a training image through the neural network 900. The weights are initially randomized before the neural network 900 is trained. The image can include, for example, an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

For a first training iteration for the neural network 900, the output will likely include values that do not give preference to any particular class due to the weights being randomly selected at initialization. For example, if the output is a vector with probabilities that the object includes different classes, the probability value for each of the different classes may be equal or at least very similar (e.g., for ten possible classes, each class may have a probability value of 0.1). With the initial weights, the neural network 900 is unable to determine low level features and thus cannot make an accurate determination of what the classification of the object might be. A loss function can be used to analyze error in the output. Any suitable loss function definition can be used. One example of a loss function includes a mean squared error (MSE). The MSE is defined as 'O Σ−ó\ddot{ω}íΩ′Ωó \acute{ε}óò\acute{η}óò, which calculates the sum of one-half times the actual answer minus the predicted (output) answer squared. The loss can be set to be equal to the value of 'O.

The loss (or error) will be high for the first training images since the actual values will be much different than the predicted output. The goal of training is to minimize the amount of loss so that the predicted output is the same as the training label. The neural network 900 can perform a backward pass by determining which inputs (weights) most contributed to the loss of the network, and can adjust the weights so that the loss decreases and is eventually minimized.

A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as \acute{∪} \acute{∪} [symbol] where w denotes a weight, wᵢ denotes the initial weight, and η denotes a learning rate. The learning rate can be set to any suitable value, with a high learning rate including larger weight updates and a lower value indicating smaller weight updates.

The neural network 900 can include any suitable deep network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. The neural network 900 can include any other deep network other than a CNN, such as an autoencoder, deep belief nets (DBNs), Recurrent Neural Networks (RNNs), among others.

FIG. 10 is a diagram illustrating an example of the Cifar-10 neural network 1000. In some cases, the Cifar-10 neural network can be trained to classify specific objects, such as lane lines. As shown, the Cifar-10 neural network 1000 includes various convolutional layers (Conv1 layer 1002, Conv2/Relu2 layer 1008, and Conv3/Relu3 layer 1014), numerous pooling layers (Pool1/Relu1 layer 1004, Pool2 layer 1010, and Pool3 layer 1016), and rectified linear unit layers mixed therein. Normalization layers Norm1 1006 and Norm2 1012 are also provided. A final layer is the ip1 layer 1018.

Another deep learning-based detector that can be used to detect or classify objects in images includes the SSD detector, which is a fast single-shot object detector that can be applied for multiple object categories or classes. Traditionally, the SSD model is designed to use multi-scale convolutional bounding box outputs attached to multiple feature maps at the top of the neural network. Such a representation allows the SSD to efficiently model diverse box shapes, such as when the size of an object is unknown in a given image. However, using the systems and techniques described herein, the sub-image extraction and the width and/or height scaling of the sub-image can allow an object detection and tracking system to avoid having to work with diverse box shapes. Rather, the object detection model of the detection and tracking system can perform object detection on the scaled image in order to detect the position and/or location of the object (e.g., a target vehicle) in the image.

FIG. 11A-FIG. 11C are diagrams illustrating an example of a single-shot object detector that models diverse box shapes. FIG. 11A includes an image and FIG. 11B and FIG. 11C include diagrams illustrating how an SSD detector (with the VGG deep network base model) operates. For example, SSD matches objects with default boxes of different aspect ratios (shown as dashed rectangles in FIG. 11B and FIG. 11C). Each element of the feature map has a number of default boxes associated with it. Any default box with an intersection-over-union with a ground truth box over a threshold (e.g., 0.4, 0.5, 0.6, or other suitable threshold) is considered a match for the object. For example, two of the 8×8 boxes (box 1102 and box 1104 in FIG. 11B) are matched with the cat, and one of the 4×4 boxes (box 1106 in FIG. 11C) is matched with the dog. SSD has multiple features maps, with each feature map being responsible for a different scale of objects, allowing it to identify objects across a large range of scales. For example, the boxes in the 8×8 feature map of FIG. 11B are smaller than the boxes in the 4×4 feature map of FIG. 11C. In one illustrative example, an SSD detector can have six feature maps in total.

For each default box in each cell, the SSD neural network outputs a probability vector of length c, where c is the number of classes, representing the probabilities of the box containing an object of each class. In some cases, a background class is included that indicates that there is no object in the box. The SSD network also outputs (for each default box in each cell) an offset vector with four entries containing the predicted offsets required to make the default box match the underlying object's bounding box. The vectors are given in the format (cx, cy, w, h), with cx indicating the center x, cy indicating the center y, w indicating the width offsets, and h indicating height offsets. The vectors are only meaningful if there actually is an object contained in the default box. For the image shown in FIG. 11A, all probability labels would indicate the background class with the exception of the three matched boxes (two for the cat, one for the dog).

As noted above, using the systems and techniques described herein, the number of scales is reduced to the scaled sub-image, upon which an object detection model can perform object detection to detect the position of an object (e.g., a target vehicle).

Another deep learning-based detector that can be used by an object detection model to detect or classify objects in images includes the You only look once (YOLO) detector, which is an alternative to the SSD object detection system. FIG. 12A through FIG. 12C are diagrams illustrating an example of a you only look once (YOLO) detector, in accordance with some examples. In particular, FIG. 12A includes an image and FIG. 12B and FIG. 12C include diagrams illustrating how the YOLO detector operates. The YOLO detector can apply a single neural network to a full image. As shown, the YOLO network divides the image into regions and predicts bounding boxes and probabilities for each region. These bounding boxes are weighted by the predicted probabilities. For example, as shown in FIG. 12A, the YOLO detector divides the image into a grid of 13-by-13 cells. Each of the cells is responsible for predicting five bounding boxes. A confidence score is provided that indicates how certain it is that the predicted bounding box actually encloses an object. This score does not include a classification of the object that might be in the box, but indicates if the shape of the box is suitable. The predicted bounding boxes are shown in FIG. 12B. The boxes with higher confidence scores have thicker borders.

Each cell also predicts a class for each bounding box. For example, a probability distribution over all the possible classes is provided. Any number of classes can be detected, such as a bicycle, a dog, a cat, a person, a car, or other suitable object class. The confidence score for a bounding box and the class prediction are combined into a final score that indicates the probability that that bounding box contains a specific type of object. For example, the gray box with thick borders on the left side of the image in FIG. 12B is 85% sure it contains the object class “dog.” There are 169 grid cells (13×13) and each cell predicts 5 bounding boxes, resulting in 1745 bounding boxes in total. Many of the bounding boxes will have very low scores, in which case only the boxes with a final score above a threshold (e.g., above a 30% probability, 40% probability, 50% probability, or other suitable threshold) are kept. FIG. 12C shows an image with the final predicted bounding boxes and classes, including a dog, a bicycle, and a car. As shown, from the 1745 total bounding boxes that were generated, only the three bounding boxes shown in FIG. 12C were kept because they had the best final scores.

In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces can be configured to communicate and/or receive wired and/or wireless data, including data according to the 3G, 4G, 5G, and/or other cellular standard, data according to the WiFi (802.11x) standards, data according to the Bluetooth™ standard, data according to the Internet Protocol (IP) standard, and/or other types of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

FIG. 13 is a diagram illustrating an example of a system for implementing certain aspects of the present technology. In particular, FIG. 13 illustrates an example of computing system 1300, which can be for example any computing device making up internal computing system, a remote computing system, a camera, or any component thereof in which the components of the system are in communication with each other using connection 1305. Connection 1305 can be a physical connection using a bus, or a direct connection into processor 1310, such as in a chipset architecture. Connection 1305 can also be a virtual connection, networked connection, or logical connection.

In some aspects, computing system 1300 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 1300 includes at least one processing unit (CPU or processor) 1310 and connection 1305 that couples various system components including system memory 1315, such as read-only memory (ROM) 1320 and random-access memory (RAM) 1325 to processor 1310. Computing system 1300 can include a cache 1312 of high-speed memory connected directly with, in close proximity to, or integrated as part of processor 1310.

Processor 1310 can include any general-purpose processor and a hardware service or software service, such as services 1332, 1334, and 1336 stored in storage device 1330, configured to control processor 1310 as well as a special-purpose processor where software instructions are incorporated into the actual processor design. Processor 1310 may essentially be a completely self-contained computing system, containing multiple cores or processors, a bus, memory controller, cache, etc. A multi-core processor may be symmetric or asymmetric.

To enable user interaction, computing system 1300 includes an input device 1345, which can represent any number of input mechanisms, such as a microphone for speech, a touch-sensitive screen for gesture or graphical input, keyboard, mouse, motion input, speech, etc. Computing system 1300 can also include output device 1335, which can be one or more of a number of output mechanisms. In some instances, multimodal systems can enable a user to provide multiple types of input/output to communicate with computing system 1300. Computing system 1300 can include communications interface 1340, which can generally govern and manage the user input and system output.

The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 1340 may also include one or more Global Navigation Satellite System (GNSS) receivers or transceivers that are used to determine a location of the computing system 1300 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1330 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 1330 can include software services, servers, services, etc., that when the code that defines such software is executed by the processor 1310, it causes the system to perform a function. In some aspects, a hardware service that performs a particular function can include the software component stored in a computer-readable medium in connection with the necessary hardware components, such as processor 1310, connection 1305, output device 1335, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections.

Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories can include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein can be replaced with less than or equal to (“ ”) and greater than or equal to (“ ”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Illustrative aspects of the disclosure include the following:
Aspect 1. An apparatus of a tracking object for performing point map registration, comprising: at least one memory; and at least one processor coupled to the at least one memory, the at least one processor configured to: obtain an image comprising a scene; determine, based on the image, a first point map representing the scene, wherein the first point map comprises a first plurality of 3D points representing the scene; determine a first plurality of point groupings, wherein each point grouping of the first plurality of point groupings is determined based on proximity of pairs of points of the first plurality of 3D points, wherein each point grouping includes two or more 3D points from the first plurality of 3D points; obtain a second point map representing the scene, wherein the second point map comprises a second plurality of 3D points representing the scene; obtain a second plurality of point groupings, wherein each point grouping of the second plurality of point groupings includes a plurality of 3D points from the second plurality of 3D points; determine a correspondence between individual point groupings of the first plurality of point groupings and individual point groupings of the second plurality of point groupings; and determine, based on the correspondence between individual point groupings of the first plurality of point groupings and individual point groupings of the second plurality of point groupings, an alignment transformation for aligning the first plurality of 3D points and the second plurality of 3D points.
Aspect 2. The apparatus of Aspect 1, wherein determining correspondence between individual point groupings of the first plurality of point groupings and individual point groupings of the second plurality of point groupings comprises determining at least one or more of the individual point groupings of the first plurality of point groupings or the individual point groupings of the second plurality of point groupings does not have a corresponding individual point grouping.
Aspect 3. The apparatus of any of Aspects 1 to 2, wherein the at least one processor is configured to: apply the alignment transformation to one of the first plurality of 3D points representing the scene or the second plurality of 3D points to generate a transformed first plurality of 3D points; and determine correspondence between the transformed first plurality of 3D points and the other of the first plurality of 3D points or the second plurality of 3D points.
Aspect 4. The apparatus of any of Aspects 1 to 3, wherein, to determine the first plurality of point groupings, the at least one processor is configured to: determine, for a first point of the first plurality of 3D points, that a first Euclidian distance between the first point of the first plurality of 3D points and a second point of the first plurality of 3D points is less than a threshold distance, wherein the second point of the first plurality of 3D points is adjacent to the first point of the first plurality of 3D points; and group, based on determining that the first Euclidian distance between the first point of the first plurality of 3D points and the second point of the first plurality of 3D points is less than the threshold distance, the first point and the second point into a first point grouping of the first plurality of point groupings.
Aspect 5. The apparatus of any of Aspects 1 to 4, wherein, to determine the first plurality of point groupings, the at least one processor is configured to: determine, for the second point of the first plurality of 3D points, that a second Euclidian distance between the second point of the first plurality of 3D points and a third point of the first plurality of 3D points is greater than the threshold distance; and based on determining that the second Euclidian distance between the second point of the first plurality of 3D points and the third point of the first plurality of 3D points is greater than the threshold distance, excluding the third point of the first plurality of 3D points from the first point grouping of the first plurality of point groupings.
Aspect 6. The apparatus of any of Aspects 1 to 5, wherein the at least one processor is configured to determine, based on determining correspondence between a first point grouping of the first plurality of point groupings and a second point grouping of the second plurality of point groupings, a correspondence between individual points of the first point grouping of the first plurality of point groupings and individual points of the second point grouping of the second plurality of point groupings.
Aspect 7. The apparatus of any of Aspects 1 to 6, wherein, to determine correspondence between individual point groupings of the first plurality of point groupings and individual point groupings of the second plurality of point groupings, the at least one processor is configured to: apply a sequential ordering for points included in each point grouping of the first plurality of point groupings based on a respective position of each pixel included in each respective point grouping of the first plurality of point groupings along an axis; and apply the sequential ordering for points included in each point grouping of the second plurality of point groupings based on a respective position of each pixel included in each respective point grouping of the second plurality of point groupings along the axis.
Aspect 8. The apparatus of any of Aspects 1 to 7, wherein the axis corresponds to at least one or more of a direction of motion of the tracking object or an optical axis associated with the image.
Aspect 9. The apparatus of any of Aspects 1 to 8, wherein, to determine correspondence between individual point groupings of the first plurality of point groupings and individual point groupings of the second plurality of point groupings, the at least one processor is configured to: determine dynamic time warping distances between each point grouping of the first plurality of point groupings and each point grouping of the second plurality of point groupings; and determine, based on the determined dynamic time warping distances, a correspondence between individual point groupings of the first plurality of point groupings and individual point groupings of the second plurality of point groupings.
Aspect 10. The apparatus of any of Aspects 1 to 9, wherein individual point groupings of the first plurality of point groupings correspond to lines in the image.
Aspect 11. The apparatus of any of Aspects 1 to 10, wherein the tracking object is a tracking vehicle.
Aspect 12. The apparatus of any of Aspects 1 to 11, wherein the apparatus of the tracking object is a computing system of the tracking vehicle.
Aspect 13. The apparatus of any of Aspects 1 to 12, wherein the at least one processor is configured to: align, based on the alignment transformation, the first plurality of 3D points and the second plurality of 3D points; and determine, based on aligning the first plurality of 3D points and the second plurality of 3D points, a localization of the tracking object relative to the second point map, wherein the second point map comprises a reference point map.
Aspect 14. The apparatus of any of Aspects 1 to 13, wherein the at least one processor is configured to: perform, based on the localization, a navigation operation.
Aspect 15. The apparatus of any of Aspects 1 to 14, wherein the reference point map comprises a HD reference point map.
Aspect 16. The apparatus of any of Aspects 1 to 15, wherein the reference point map is obtained from a reference map service.
Aspect 17. A method for performing point map registration comprising: obtaining an image comprising a scene; determining, based on the image, a first point map representing the scene, wherein the first point map comprises a first plurality of 3D points representing the scene; determining a first plurality of point groupings, wherein each point grouping of the first plurality of point groupings is determined based on proximity of pairs of points of the first plurality of 3D points, wherein each point grouping includes two or more 3D points from the first plurality of 3D points; obtaining a second point map representing the scene, wherein the second point map comprises a second plurality of 3D points representing the scene; obtaining a second plurality of point groupings, wherein each point grouping of the second plurality of point groupings includes a plurality of 3D points from the second plurality of 3D points; determining a correspondence between individual point groupings of the first plurality of point groupings and individual point groupings of the second plurality of point groupings; and determining, based on the correspondence between individual point groupings of the first plurality of point groupings and individual point groupings of the second plurality of point groupings, an alignment transformation for aligning the first plurality of 3D points and the second plurality of 3D points.
Aspect 18. The method of Aspect 17, wherein determining correspondence between individual point groupings of the first plurality of point groupings and individual point groupings of the second plurality of point groupings comprises determining at least one or more of the individual point groupings of the first plurality of point groupings or the individual point groupings of the second plurality of point groupings does not have a corresponding individual point grouping.
Aspect 19. The method of any of Aspects 17 to 18, further comprising: applying the alignment transformation to one of the first plurality of 3D points representing the scene or the second plurality of 3D points to generate a transformed first plurality of 3D points; and determining correspondence between the transformed first plurality of 3D points and the other of the first plurality of 3D points or the second plurality of 3D points.
Aspect 20. The method of any of Aspects 17 to 19, further comprising: determining, for a first point of the first plurality of 3D points, that a first Euclidian distance between the first point of the first plurality of 3D points and a second point of the first plurality of 3D points is less than a threshold distance, wherein the second point of the first plurality of 3D points is adjacent to the first point of the first plurality of 3D points; and grouping, based on determining that first Euclidian distance between the first point of the first plurality of 3D points and the second point of the first plurality of 3D points is less than the threshold distance, the first point and the second point into a first point grouping of the first plurality of point groupings.
Aspect 21. The method of any of Aspects 17 to 20, further comprising: determining, for the second point of the first plurality of 3D points, that a second Euclidian distance between the second point of the first plurality of 3D points and a third point of the first plurality of 3D points is greater than the threshold distance; and based on determining that the second Euclidian distance between the second point of the first plurality of 3D points and the third point of the first plurality of 3D points is greater than the threshold distance, excluding the third point of the first plurality of 3D points from the first point grouping of the first plurality of point groupings.
Aspect 22. The method of any of Aspects 17 to 21, further comprising determining, based on determining correspondence between a first point grouping of the first plurality of point groupings and a second point grouping of the second plurality of point groupings, a correspondence between individual points of the first point grouping of the first plurality of point groupings and individual points of the second point grouping of the second plurality of point groupings.
Aspect 23. The method of any of Aspects 17 to 22 further comprising: applying a sequential ordering for points included in each point grouping of the first plurality of point groupings based on a respective position of each pixel included in each respective point grouping of the first plurality of point groupings along an axis; and applying the sequential ordering for points included in each point grouping of the second plurality of point groupings based on a respective position of each pixel included in each respective point grouping of the second plurality of point groupings along the axis.
Aspect 24. The method of any of Aspects 17 to 23, wherein the axis corresponds to at least one or more of a direction of motion of a tracking object or an optical axis associated with the image.
Aspect 25. The method of any of Aspects 17 to 24, further comprising: determining dynamic time warping distances between each point grouping of the first plurality of point groupings and each point grouping of the second plurality of point groupings; and determining, based on the determined dynamic time warping distances, a correspondence between individual point groupings of the first plurality of point groupings and individual point groupings of the second plurality of point groupings.
Aspect 26. The method of any of Aspects 17 to 25, wherein individual point groupings of the first plurality of point groupings correspond to lines in the image.
Aspect 27. The method of any of Aspects 17 to 26, further comprising: aligning, based on the alignment transformation, the first plurality of 3D points and the second plurality of 3D points; and determining, based on aligning the first plurality of 3D points and the second plurality of 3D points, a localization of a tracking object relative to the second point map, wherein the second point map comprises a reference point map.
Aspect 28. The method of any of Aspects 17 to 27, further comprising performing, based on the localization, a navigation operation.
Aspect 29. The method of any of Aspects 17 to 28, wherein the reference point map comprises a HD reference point map.
Aspect 30. The method of any of Aspects 17 to 29, wherein the reference point map is obtained from a reference map service.
Aspect 31. A non-transitory computer-readable storage medium having stored thereon instructions which, when executed by one or more processors, cause the one or more processors to perform any of the operations of aspects 1 to 30.
Aspect 32. An apparatus comprising means for performing any of the operations of aspects 1 to 30.

1. An apparatus of a tracking object for performing point map registration, comprising:
at least one memory; and
at least one processor coupled to the at least one memory, the at least one processor configured to:
obtain an image comprising a scene;
determine, based on the image, a first point map representing the scene, wherein the first point map comprises a first plurality of three-dimensional (3D) points representing the scene;
determine a first plurality of point groupings, wherein each point grouping of the first plurality of point groupings is determined based on proximity of pairs of points of the first plurality of 3D points, wherein each point grouping includes two or more 3D points from the first plurality of 3D points;
obtain a second point map representing the scene, wherein the second point map comprises a second plurality of 3D points representing the scene;
obtain a second plurality of point groupings, wherein each point grouping of the second plurality of point groupings includes a plurality of 3D points from the second plurality of 3D points;
determine a correspondence between individual point groupings of the first plurality of point groupings and individual point groupings of the second plurality of point groupings; and
determine, based on the correspondence between individual point groupings of the first plurality of point groupings and individual point groupings of the second plurality of point groupings, an alignment transformation for aligning the first plurality of 3D points and the second plurality of 3D points.

2. The apparatus of claim 1, wherein determining correspondence between individual point groupings of the first plurality of point groupings and individual point groupings of the second plurality of point groupings comprises determining at least one or more of the individual point groupings of the first plurality of point groupings or the individual point groupings of the second plurality of point groupings does not have a corresponding individual point grouping.

3. The apparatus of claim 1, wherein the at least one processor is configured to:
apply the transformation to one of the first plurality of 3D points representing the scene or the second plurality of 3D points to generate a transformed first plurality of 3D points; and
determine correspondence between the transformed first plurality of 3D points and the other of the first plurality of 3D points or the second plurality of 3D points.

4. The apparatus of claim 1, wherein, to determine the first plurality of point groupings, the at least one processor is configured to:
determine, for a first point of the first plurality of 3D points, that a first Euclidian distance between the first point of the first plurality of 3D points and a second point of the first plurality of 3D points is less than a threshold distance, wherein the second point of the first plurality of 3D points is adjacent to the first point of the first plurality of 3D points; and
group, based on determining that the distance between the first point of the first plurality of 3D points and the second point of the first plurality of 3D points adjacent to the first point is less than the threshold distance, the first point and the second point into a first point grouping of the first plurality of point groupings.

5. The apparatus of claim 4, wherein, to determine the first plurality of point groupings, the at least one processor is configured to:
determine, for the second point of the first plurality of 3D points, that a second Euclidian distance between the second point of the first plurality of 3D points and a third point of the first plurality of 3D points is greater than the threshold distance; and
based on determining that the second Euclidian distance between the second point of the first plurality of 3D points and the third point of the first plurality of 3D points is greater than the threshold distance, excluding the third point of the first plurality of 3D points from the first point grouping of the first plurality of point groupings.

6. The apparatus of claim 1, wherein the at least one processor is configured to determine, based on determining correspondence between a first point grouping of the first plurality of point groupings and a second point grouping of the second plurality of point groupings, a correspondence between individual points of the first point grouping of the first plurality of point groupings and individual points of the second point grouping of the second plurality of point groupings.

7. The apparatus of claim 1, wherein, to determine correspondence between individual point groupings of the first plurality of point groupings and individual point groupings of the second plurality of point groupings, the at least one processor is configured to:
apply a sequential ordering for points included in each point grouping of the first plurality of point groupings based on a respective position of each pixel included in each respective point grouping of the first plurality of point groupings along an axis; and
apply the sequential ordering for points included in each point grouping of the second plurality of point groupings based on a respective position of each pixel included in each respective point grouping of the second plurality of point groupings along the axis.

8. The apparatus of claim 7, wherein the axis corresponds to at least one or more of a direction of motion of the tracking object or an optical axis associated with the image.

9. The apparatus of claim 1, wherein, to determine correspondence between individual point groupings of the first plurality of point groupings and individual point groupings of the second plurality of point groupings, the at least one processor is configured to: determine dynamic time warping distances between each point grouping of the first plurality of point groupings and each point grouping of the second plurality of point groupings; and
determine, based on the dynamic time warping distances, a correspondence between individual point groupings of the first plurality of point groupings and individual point groupings of the second plurality of point groupings.

10. The apparatus of claim 1, wherein individual point groupings of the first plurality of point groupings correspond to lines in the image.

11. The apparatus of claim 1, wherein the tracking object is a tracking vehicle.

12. The apparatus of claim 11, wherein the apparatus of the tracking object is a computing system of the tracking vehicle.

13. The apparatus of claim 1, wherein the at least one processor is configured to:
align, based on the alignment transformation, the first plurality of 3D points and the second plurality of 3D points; and
determine, based on aligning the first plurality of 3D points and the second plurality of 3D points, a localization of the tracking object relative to the second point map, wherein the second point map comprises a reference point map.

14. The apparatus of claim 13, wherein the at least one processor is configured to perform, based on the localization, a navigation operation.

15. The apparatus of claim 13, wherein the reference point map comprises a high definition (HD) reference point map.

16. The apparatus of claim 15, wherein the reference point map is obtained from a reference map service.

17. A method for performing point map registration comprising:
obtaining an image comprising a scene;
determining, based on the image, a first point map representing the scene, wherein the first point map comprises a first plurality of 3D points representing the scene;
determining a first plurality of point groupings, wherein each point grouping of the first plurality of point groupings is determined based on proximity of pairs of points of the first plurality of 3D points, wherein each point grouping includes two or more 3D points from the first plurality of 3D points;
obtaining a second point map representing the scene, wherein the second point map comprises a second plurality of 3D points representing the scene;
obtaining a second plurality of point groupings, wherein each point grouping of the second plurality of point groupings includes a plurality of 3D points from the second plurality of 3D points;
determining a correspondence between individual point groupings of the first plurality of point groupings and individual point groupings of the second plurality of point groupings; and
determining, based on the correspondence between individual point groupings of the first plurality of point groupings and individual point groupings of the second plurality of point groupings, an alignment transformation for aligning the first plurality of 3D points and the second plurality of 3D points.

18. The method of claim 17, wherein determining correspondence between individual point groupings of the first plurality of point groupings and individual point groupings of the second plurality of point groupings comprises determining at least one or more of the individual point groupings of the first plurality of point groupings or the individual point groupings of the second plurality of point groupings does not have a corresponding individual point grouping.

19-26. (canceled)

27. The method of claim 17, further comprising:
aligning, based on the alignment transformation, the first plurality of 3D points and the second plurality of 3D points; and
determining, based on aligning the first plurality of 3D points and the second plurality of 3D points, a localization of a tracking object relative to the second point map, wherein the second point map comprises a reference point map.

28. The method of claim 27, further comprising performing, based on the localization, a navigation operation.

29-30. (canceled)
